(19) United States
(12) Patent Application Publication
(10) Pub. No.: US 2023/0410066 A1
(43) Pub. Date: Dec. 21, 2023

(54) SYSTEM AND METHOD FOR NON-FUNGIBLE TOKEN ECONOMY SINKS

(71) Applicant: Disney Enterprises, Inc., Burbank, CA (US)

(72) Inventors: Alif Khalfan, Redwood City, CA (US); Zachary Shalett, Los Angeles, CA (US); Malcolm E. Murdock, Los Angeles, CA (US); Brianna Cochran, Los Angeles, CA (US); Benjamin Lopez Barba, Burbank, CA (US)

(21) Appl. No.: 18/133,951

(22) Filed: Apr. 12, 2023

Related U.S. Application Data
(60) Provisional application No. 63/343,456, filed on May 18, 2022.

(51) Int. Cl. G06Q 20/06; G06Q 20/40

(52) U.S. Cl. CPC G06Q 20/065; G06Q 2220/00; G06Q 20/401

(57) ABSTRACT

A system includes a hardware processor and a memory storing software code. The hardware processor executes the software code to determine how many users are present at a location at a starting time of an NFT acquisition event, identify, based on how many users are present, a collaborative activity for the users, the collaborative activity requiring relinquishment of a plurality of NFTs, and communicate the collaborative activity to the users. The hardware processor further executes the software code to verify that the collaborative activity has been completed, and provide, in response to verifying, one or more new NFT(s) for distribution to at least one of the users, wherein (i) a value associated with the new NFT(s) exceeds a value of the NFTs relinquished, or (ii) a number of the NFTs relinquished exceeds a number of the new NFT(s).

### RELATED APPLICATIONS

The present application claims the benefit of and priority to a pending Provisional Patent Application Ser. No. 63/343,456 filed on May 18, 2022, and titled “NFT Recycling and Retirement,” which is hereby incorporated fully by reference into the present application.

### BACKGROUND

Although existing non-fungible token (NFT) minting and distribution schemes advantageously enable NFT collectors to buy, sell, or trade NFTs at will, those conventional schemes do nothing to protect the value of existing NFTs as more and more of such assets become available. However, the increasing proliferation of NFTs threatens to undesirably dilute the value of existing NFTs, both their objective market value and the subjective value arising from the perception by an NFT owner that their NFT asset is rare or precious. That is to say, conventional NFT minting and distribution approaches fail to incentivize the relinquishment of existing NFTs. Thus there is a need in the art for an NFT marketplace solution capable of preserving or enhancing the value of existing NFTs without constraining the production and exchange of new NFTs.

### BRIEF DESCRIPTION OF THE DRAWINGS

FIG. 1 shows a system for performing non-fungible token (NFT) retirement, according to one implementation;

FIG. 2 shows a client device configured to mediate collection and relinquishment of NFTs, according to one implementation; and

FIG. 3 shows a flowchart presenting an exemplary method for performing NFT retirement, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

The technology known as a non-fungible token (NFT) allows individual artists and companies to sell ownership rights to a digital asset, such as a file containing a photo or other image, video, audio, or any other desirable digital representation of a real or virtual object. An NFT is a unit of data stored on a secure digital ledger, such as a blockchain for example, that certifies a digital asset to be unique and therefore non-fungible. An NFT can be used to represent a digital asset which is typically stored in and accessible via the cloud, and confer ownership of that digital asset to an individual or entity. However, in contrast to traditional ownership rights, ownership of an NFT does not prevent others from accessing, or even copying, the digital asset associated with the NFT.

The present application discloses systems and methods for performing NFT retirement that address emerging challenges to maintaining and enhancing NFT value. As noted above, although existing NFT minting and distribution schemes advantageously enable NFT collectors to buy, sell, or trade NFTs at will, those conventional schemes do nothing to protect the value of existing NFTs as more and more of such assets become available. However, and as also noted above, the increasing proliferation of NFTs threatens to undesirably dilute the value of existing NFTs, both their objective market value and the subjective value arising from the perception by an NFT owner that their NFT asset is rare or precious. Thus, conventional NFT minting and distribution approaches fail to incentivize the relinquishment of existing NFTs, either for recycling, i.e., through re-minting for example, or for retirement (hereinafter “burning”). By contrast, the present NFT retirement solution advantageously enables the rewarding of NFT collectors for their real or virtual presence at particular locations, their participation in specific collaborative activities, and their willingness to relinquish an NFT presently in their possession. Consequently, the present to NFT retirement solution can add value to the NFTs remaining in circulation by enhancing their scarcity.

It is noted that, as defined in the present application, the term “NFT asset” may refer to any digital asset having its ownership certified by an NFT. Examples of an NFT asset may include a digital file containing an image or images, video without audio, audio without video, or audio-video (AV) content, such as all or part of a television (TV) episode, movie, or video game, to name a few. In addition, or alternatively, in some implementations, an NFT asset may be or include a digital representation of persons, fictional characters, locations, objects, and identifiers such as brands and logos, for example, which populate a virtual reality (VR), augmented reality (AR), or mixed reality (MR) environment. Such digital representations may depict virtual worlds that can be experienced by any number of users synchronously and persistently, while providing continuity of data such as personal identity, user history, entitlements, possessions, payments, and the like. Moreover, in some implementations, an NFT asset may be a hybrid of traditional audio-video and fully immersive VR/AR/MR experiences, such as interactive video.

It is further noted that the term “NFT wallet” may refer to any secure software application assigned to an owner of an NFT asset that stores the NFT credentials (e.g., public and private keys, certifying ownership of the NFT asset), and enables the NFT asset owner to reassign, i.e., sell or otherwise transfer ownership of the NFT asset to another person or entity. It is also noted that the relationship between an NFT asset and an NFT wallet is many-to-one rather than one-to-one. That is to say, in some implementations, the same NFT wallet may store NFT credentials for each of multiple NFT assets. However, the NFT credentials of an NFT asset are uniquely present in only one NFT wallet at a time.

Moreover, as defined in the present application, the term “burning,” when applied to an NFT, refers to the permanent removal of that NFT from circulation. Thus, burning may refer to destruction of an existing NFT, or to the persistent sequestering of an NFT in a digital wallet that is inaccessible for use to purchase, trade, award, or otherwise confer possession or ownership of any NFT stored within it.

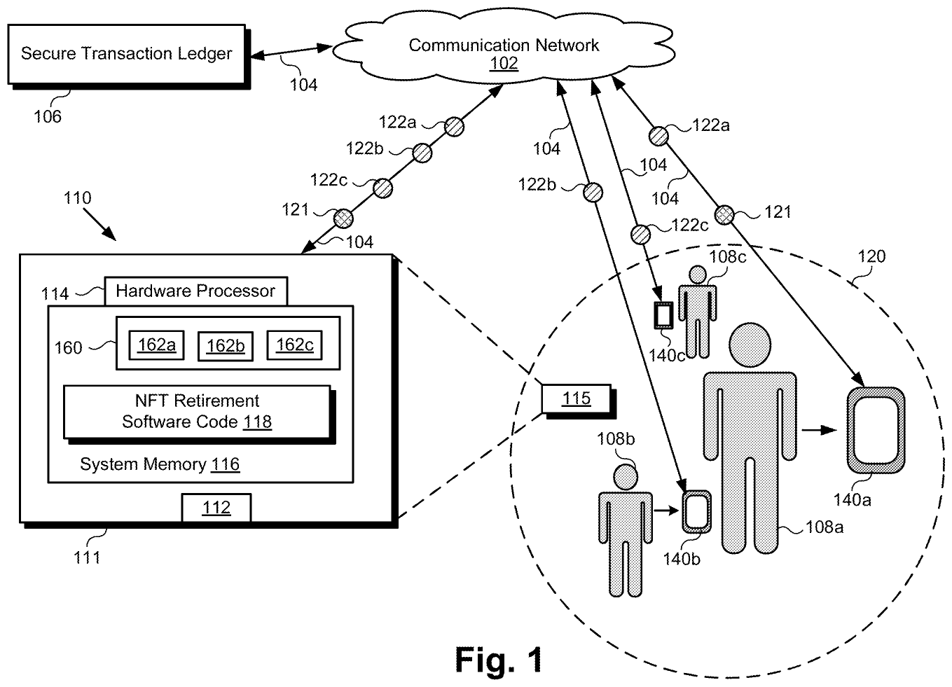

FIG. 1 shows system 110 configured to recycle and retire NFTs, according to one exemplary implementation. As shown in FIG. 1, system 110 includes computing platform 111 having transceiver 112, hardware processor 114, and system memory 116 implemented as a computer-readable non-transitory storage medium. According to the present exemplary implementation, system memory 116 stores NFT retirement software code 118, and user history database 160 including user histories 162a, 162b, and 162c corresponding respectively to NFT owners 108a, 108b, and 108c (hereinafter “users” 108a, 108b, and 108c). It is noted that each of user histories 162a, 162b, and 162c may include a record of the ownership history and participatory history of respective users 108a, 108b, and 108c. That is to say, user history 162a may identify NFTs presently owned by user 108a, NFTs previously owned by user 108a, NFTs previously relinquished by user 108a, past participation by user 108a in other NFT retirement events, and NFTs previously awarded to user 108a for such participation, while user histories 162b and 162c may include the same information regarding respective users 108b and 108c.

FIG. 1 further shows users 108a, 108b, and 108c to be present at location 120 including interactive element 115, client devices 140a, 140b, and 140c utilized by respective users 108a, 108b, and 108c, secure transaction ledger 106, communication network 102 and network communication links 104 communicatively coupling system 110 to secure transaction ledger 106 and client devices 140a, 140b, and 140c. Also shown in FIG. 1 are one or more new NFTs 121 (hereinafter “new NFT(s) 121”) distributed to client device 140a of user 108a and existing NFTs 122a, 122b, and 122c relinquished to system 110 by respective users 108a, 108b, and 108c.

With respect to the representation of system 110 shown in FIG. 1, it is noted that although NFT retirement software code 118 is depicted as being stored in system memory 116 for conceptual clarity, more generally, system memory 116 may take the form of any computer-readable non-transitory storage medium. The expression “computer-readable non-transitory storage medium,” as used in the present application, refers to any medium, excluding a carrier wave or other transitory signal that provides instructions to hardware processor of a computing platform, such as hardware processor 114 of computing platform 111. Thus, a computer-readable non-transitory storage medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory storage media include, for example, optical discs, RAM, programmable read-only memory (PROM), erasable PROM (EPROM), and FLASH memory.

It is further noted that although FIG. 1 depicts NFT retirement software code 118 as being entirely located in a single instance of system memory 116, that representation is also merely provided as an aid to conceptual clarity. More generally, system 110 may include one or more computing platforms, such as computer servers for example, which may be co-located, or may form an interactively linked but distributed system, such as a cloud-based system, for instance. As a result, hardware processor 114 and system memory 116 may correspond to distributed processor and memory resources of system 110. Thus, it is to be understood that various software modules of NFT retirement software code 118 may be stored remotely from one another within the distributed memory resources of system 110.

It is also noted that although FIG. 1 depicts three users 108a, 108b, and 108c and three corresponding user histories 162a, 162b, and 162c, those representations are also provided merely by way of example. More generally the users of system 110 may include less than three users, or greater than three users such as tens, hundreds, or thousands of users, some or all of whom may have user histories stored on user history database 160. Thus, in various implementations, the number of user histories stored in user database 160 may or may not match the number of users (e.g., there may be less user histories stored in user database 160 than the number of users).

Hardware processor 114 may include multiple hardware processing units, such as one or more central processing units, one or more graphics processing units, one or more tensor processing units, one or more field-programmable gate arrays (FPGAs), and an application programming interface (API) server, for example. By way of definition, as used in the present application, the terms “central processing unit” (CPU), “graphics processing unit” (GPU), and “tensor processing unit” (TPU) have their customary meaning in the art. That is to say, a CPU includes an Arithmetic Logic Unit (ALU) for carrying out the arithmetic and logical operations of computing platform 111, as well as a Control Unit (CU) for retrieving programs, such as NFT retirement software code 118, from system memory 116, while a GPU may be implemented to reduce the processing overhead of the CPU by performing computationally intensive graphics or other processing tasks. A TPU is an application-specific integrated circuit (ASIC) configured specifically for artificial intelligence (AI) applications such as machine learning modeling.

In some implementations, computing platform 111 may correspond to one or more web servers accessible over a packet-switched network such as the Internet, for example. Alternatively, computing platform 111 may correspond to one or more computer servers supporting a wide area network (WAN), a local area network (LAN), or included in another type of private or limited distribution network. In addition, or alternatively, in some implementations, system 110 may utilize a local area broadcast method, such as User Datagram Protocol (UDP) or Bluetooth, for instance. Furthermore, in some implementations, system 110 may be implemented virtually, such as in a data center. For example, in some implementations, system 110 may be implemented in software, or as virtual machines. Moreover, in some implementations, communication network 102 may be a high-speed network suitable for high performance computing (HPC), for example a 10 GigE network or an Infiniband network.

In some implementations, computing platform 111 may be a component of interactive element 115 present at location 120. It is noted that location 120 may be a physical real-world location or a virtual world location where NFTs can be traded, exchanged, granted, or burned. It is noted that, in various implementations in which location 120 is a real-world location, location 120 may be the entire limits of a city, a recreation or resort property, a theme park or other entertainment venue, a cruise ship, or the immediate vicinity, e.g., within ten feet or any other predetermined distance of the interactive element 115, a physical object at the location 120, or a coordinate (e.g., latitude and longitude). In implementations in which location 120 is a real-world location, interactive element 115 may be an interactive environmental element of location 120 where the technology is hidden from users 108a, 108b, and 108c, such as a “Magic Well” for example, configured to create a narrative, as discussed in greater detail below.

Transceiver 112 of system 110 may be implemented as any suitable wireless communication unit. For example, transceiver 112 may be implemented as a fourth generation (4G) wireless transceiver, or as a 5G wireless transceiver. In addition, or alternatively, transceiver 112 may be configured for communications using one or more of Wireless Fidelity (Wi-Fi), Worldwide Interoperability for Microwave Access (WiMAX), Bluetooth, Bluetooth low energy, ZigBee, radio-frequency identification (RFID), near-field communication (NFC), and 60 GHz wireless communications methods.

Secure transaction ledger 106 may take the form of a public or private secure transaction ledger. Examples of such secure transaction ledgers may include Blockchain,

Hashgraph, Directed Acyclic Graph (DAG), and Holochain ledgers, to name a few. In use cases in which secure transaction ledger 106 is a blockchain ledger, it may be advantageous or desirable to implement secure transaction ledger 106 to utilize a consensus mechanism having a proof-of-stake (PoS) protocol, rather than the more energy intensive proof-of-work (PoW) protocol. Although secure transaction ledger 106 is shown to be remote from system 110 in FIG. 1, such as a cloud-based or distributed secure transaction ledger, that implementation is merely exemplary. In other implementations, secure transaction ledger 106 may be stored in system memory 116 and may be controlled by system 110.

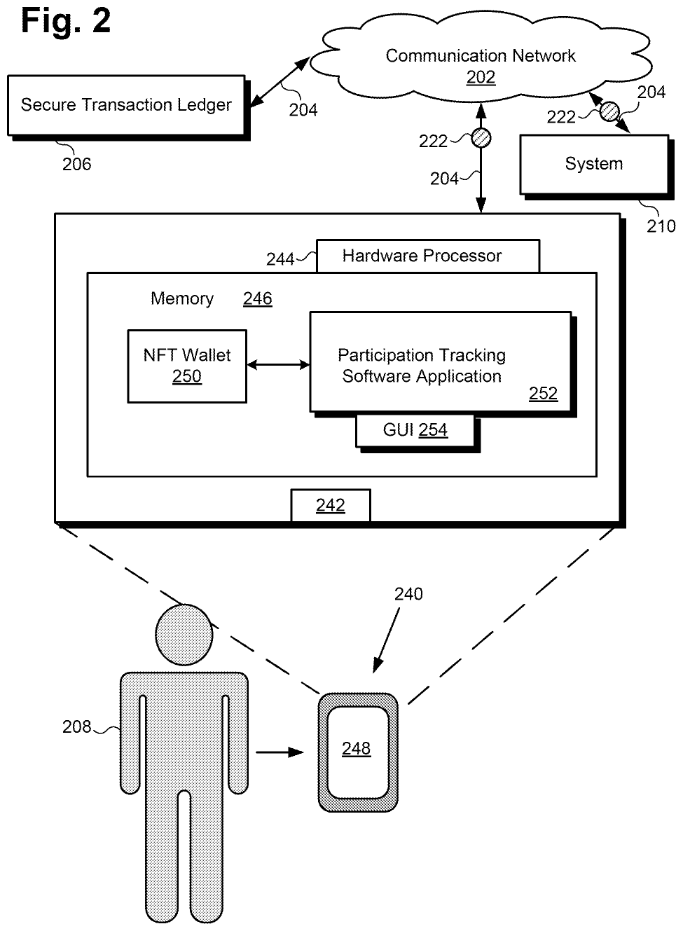

FIG. 2 shows client device 240 of NFT collector 208 (hereinafter “user 208”), configured to mediate collection and relinquishment of NFTs, such as relinquishment of existing NFT 222 for example, according to one implementation. As shown in FIG. 2, client device 240 includes transceiver 242, hardware processor 244, display 248, and memory 246 implemented as a computer-readable non-transitory storage medium storing NFT wallet 250 and participation tracking software application 252 providing GUI 254. Also shown in FIG. 2 are system 210, communication network 202, network communication links 204, and secure transaction ledger 206.

Although client device 240 is shown as a smartphone in FIG. 1 that representation is provided merely as an example. More generally, client device 240 may be any suitable mobile or stationary computing device or system that implements data processing capabilities sufficient to provide GUI 254, support connections to communication network 202, and implement the functionality ascribed to client device 240 herein. For example, in other implementations, client device 240 may take the form of a desktop computer, laptop computer, tablet computer, smart TV, game platform, a smart wearable device, such as a smartwatch for example, or an AR or VR device.

Transceiver 242 may be implemented as any suitable wireless communication unit. For example, transceiver 112 may be implemented as a 4G wireless transceiver, or as a 5G wireless transceiver. In addition, or alternatively, transceiver 242 may be configured for communications using one or more of Wi-Fi, WiMAX, Bluetooth, Bluetooth low energy, ZigBee, RFID, NFC, and 60 GHz wireless communications methods.

With respect to display 248 of client device 240, display 248 may be physically integrated with client device 240 or may be communicatively coupled to but physically separate from client device 240. For example, where client device 240 is implemented as a smartphone, laptop computer, or tablet computer, display 248 will typically be integrated with client device 240. By contrast, where client device 240 is implemented as a desktop computer, display 248 may take the form of a monitor separate from client device 240 in the form of a computer tower. Furthermore, display 248 of client device 240 may be implemented as a liquid crystal display (LCD), a light-emitting diode (LED) display, an organic light-emitting diode (OLED) display, a quantum dot (QD) display, or any other suitable display screen that performs a physical transformation of signals to light.

Participation tracking software application 252 may be configured to initiate a secure and authorized communication session in order to use transceiver 242 to receive or transmit Global Positioning System (GPS) data or other geolocation data in the form of NFC data, Bluetooth or Bluetooth LE data, or RFID data, as well as to track the progress of an ongoing activity, such as a quest, game, or other collaborative activity, that user 208 may be participating in.

According to the exemplary implementation shown in FIG. 2, NFT wallet 250 can store NFT(s) on client device 240. However, in other implementations, NFT wallet 250 may not be resident on client device 240, but may be a virtual wallet remote from client device 240, such as a cloud-based virtual wallet accessible to client device 240 via communication network 202 and network communication links 204. In yet other implementations, NFT wallet 250 may be a hardware cryptocurrency wallet, such as a Ledger Nano S® device or the like.

System 210, communication network 202, network communication links 204, and secure transaction ledger 206 correspond respectively in general to system 110, communication network 102, network communication links 104, and secure transaction ledger 106, in FIG. 1. Thus, system 210, communication network 202, network communication links 204, and secure transaction ledger 206 may share any of the characteristics attributed to respective system 110, communication network 102, network communication links 104, and secure transaction ledger 106 by the present disclosure, and vice versa.

Moreover, user 208, in FIG. 2, corresponds in general to any one or all of users 108a, 108b, and 108c in FIG. 1, while client device 240 corresponds in general to any or all of client devices 140a, 140b, and 140c. Thus, users 108a, 108b, and 108c may share any of the characteristics attributed to user 208 by the present disclosure, and vice versa, while client devices 140a, 140b, and 140c may share any of the characteristics attributed to client device 240, and vice versa. That is to say, although not shown in FIG. 1, each of client devices 140a, 140b, and 140c may include features corresponding respectively to transceiver 242, hardware processor 244, and memory 246 storing NFT wallet 250, participation tracking software application 252 providing GUI 254, and display 248.

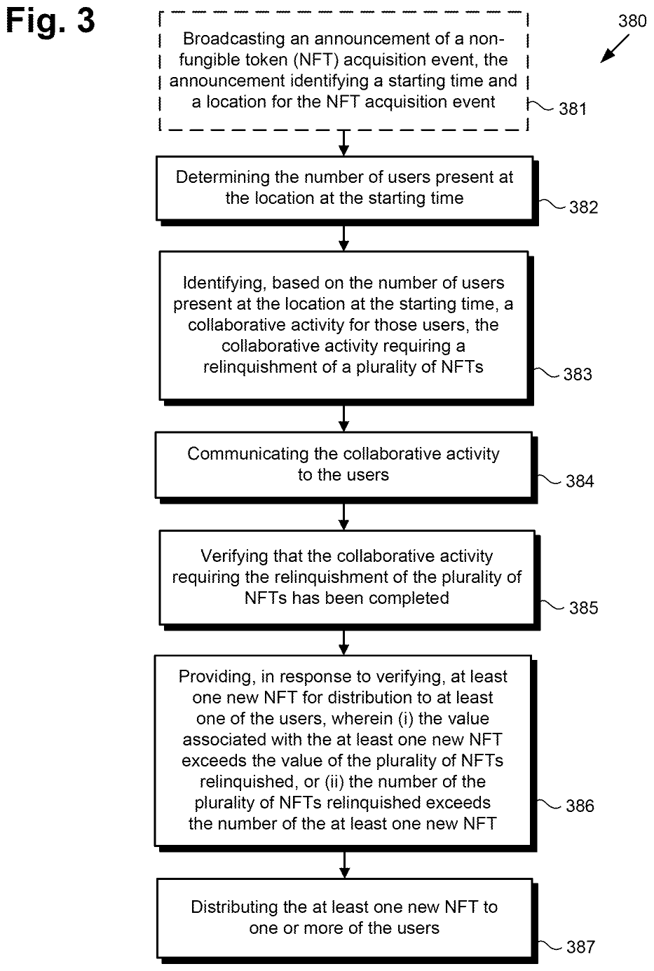

The functionality of system 110 will be further described below with reference to FIG. 3. FIG. 3 shows flowchart 380 presenting an exemplary method for performing NFT retirement, according to one implementation. With respect to the method outlined by FIG. 3, it is noted that certain details and features have been left out of flowchart 380 in order not to obscure the discussion of the inventive features in the present application.

Referring to FIG. 3 with further reference to FIG. 1, in some implementations, flowchart 380 may include broadcasting an announcement of an NFT acquisition event, the announcement identifying a starting time and location 120 for the NFT acquisition event (action 381). In some implementations, the announcement may be broadcast in action 381 by being transmitted to client devices 140a, 140b, and 140c of users 108a, 108b, and 108c present at a particular location 120 via communication network 102 and network communication links 140 (e.g., as a text message or pop-up notification). Alternatively, or in addition, the announcement may be broadcast by being displayed on an electronic billboard or other display device at location 120, or may be broadcast as speech via a sound system at location 120. The announcement may be broadcast, in action 381, by NFT retirement software code 118, executed by hardware processor 114 of system 110.

It is noted that action 381 is optional, and in some implementations may be omitted from the method outlined by flowchart 380. For example, in some implementations the NFT acquisition event may be a pre-advertised event broadcast via a website, a commercial/advertisement, email, an electronic calendar, one or more social media platforms, or one or more content streaming services, rather than by system 110.

Continuing to refer to FIGS. 1 and 3 in combination, flowchart 380 includes determining the number of users 108a, 108b, and 108c present at location 120 at the starting time for the NFT acquisition event (action 382). Action 382 may be performed by NFT retirement software code 118, executed by hardware processor 114 of system 110.

It is noted that, as defined for the purposes of the present application, the expression “at the starting time” refers to a predetermined time interval that includes the starting time identified in the announcement broadcast in action 381. For example, where that starting time is identified as 10:00 a.m., the expression “at the starting time” may refer to a predetermined time interval of several minutes, such as five minutes or ten minutes for example, beginning at 10:00 a.m. Thus, “at the starting time” may refer to the interval from 10:00 a.m. to 10:05 a.m., or 10:10 a.m., or any other time interval deemed to be appropriate. It is further noted that users 108a, 108b, and 108c are NFT owners eligible and desirous of participating in the NFT acquisition event announced in action 381. Thus, in use cases in which location 120 is a hotel property, cruise ship, or large geographical area including many persons, users 108a, 108b, and 108c may be a subset of all persons present at location 120 at the starting time identified in the announcement.

Eligibility of each of users 108a, 108b, and 108c to participate in the NFT acquisition event may vary from NFT acquisition event to event. In some instances, there may be substantially no eligibility criteria, while in other instances eligibility may be based at least in part on their respective user histories 162a, 162b, and 162c. In some implementations, determination of the number of users 108a, 108b, and 108c may be based on an affirmative opt-in action by users 108a, 108b, and 108c, either at location 120 at the starting time, or via client devices 140a/240, 140b/240, and 140c/240.

As noted above, location 120 may be a physical real-world location or a virtual world location where NFTs can be traded, exchanged, granted, or burned. In some implementations in which location 120 is a real-world location, location 120 may include interactive element 115. It is noted that, in various implementations in which location 120 is a real-world location, location 120 may be the entire limits of a city, a recreation or resort property, a theme park or other entertainment venue, a cruise ship, or the immediate vicinity, e.g., within ten feet or any other predetermined distance of interactive element 115, a physical object at location 120, or a coordinate (e.g., latitude and longitude).

The concurrent presence of users 108a, 108b, and 108c at location 120 when location 120 is a real-world location may be confirmed to an arbitrary level of precision using one or more of GPS data, RFID recognition, NFC recognition, or Bluetooth LE communications, to name a few examples.

Analogously, in implementations in which location 120 is a virtual location, the concurrent presence of users 108a. 108b, and 108c at virtual location 120 may be confirmed using cookies or other tracking tokens employed by virtual location 120. In implementations in which location 120 is a virtual world location, location 120 may be or include digital representations of persons, fictional characters, locations, objects, and identifiers such as brands and logos, for example, which populate a VR, AR, or MR environment. Moreover, such a virtual world location may be one that can be experienced by any number of users synchronously and persistently, while providing continuity of data such as personal identity, user history, entitlements, possessions, payments, and the like. Furthermore, such a virtual world location may include a hybrid of traditional audio-video based and fully immersive VR/AR/MR experiences, such as interactive video. Thus, in some implementations, location 120 may be or include a virtual venue of an interactive video environment providing at least one of a virtual VR, AR, MR experience to users 108a, 108b, and 108c.

Continuing to refer to FIGS. 1 and 3 in combination, flowchart 380 further includes identifying, based on the number of users 108a, 108b, and 108c present at location 120 at the starting time, a collaborative activity for users 108a, 108b, and 108c, the collaborative activity requiring relinquishment of a plurality of NFTs (action 383). Based on any one or more of a number of parameters, including the number of users 108a, 108b, and 108c present at location 120 at the starting time, a shared goal, quest, or other activity can be determined by system 110. These parameters may include the current external environment (e.g. how many users there are nearby, the type of venue, an event taking place at the venue, current weather conditions, date/time of day, or other tracked activities), or by internal parameters (e.g., how many times a specific activity has been completed before, difficulty levels, availability of rewards, and so forth).

By way of example, in one use case, computing platform 111 incorporated into a physical interactive element 115 (e.g., a Magic Well) at location 120 may identify a challenge (e.g., the “Character A Footwear Challenge”), in which users who have previously earned Character A related NFTs, either through purchases or obtained through other activities, are encouraged to participate. In the challenge, Character A related NFTs including one or more specific footwear features, such as style, color, fasteners, and the like, are to be relinquished to system 110 to be burned. Users 108a, 108b, and 108c have the opportunity to leverage their existing NFTs 122a, 122b, and 122c to satisfy the required footwear features, and/or hunt throughout location 120 for other NFTs that include those features.

It is noted that different NFTs owned by users 108a, 108b, and 108c may differ in value. Moreover, in some use cases, one or more of users 108a, 108b, and 108c may own a plurality of NFTs related to Character A. In some of those implementations, the user owning multiple Character A related NFTs may decide at their own discretion which or how many NFTs to relinquish. However, in other implementations, based on the user history of that particular user, hardware processor 114 may execute NFT retirement software code 118 to identify the NFT to be relinquished, either at random, or based on some specific criterion such as the value or age of the NFT, or the length of time that the NFT has been owned by that user. In further implementations, where it is desirable to retire a specific NFT, a participating user may be required to relinquish any or all duplicates of the specific NFT.

Moreover, in some implementations, the collaborative activity identified in action 383 may require each of users 108a, 108b, and 108c to relinquish at least one of the plurality of NFTs. The identification of the collaborative activity based on the number of users 108a, 108b, and 108c present at location 120 at the starting time, in action 383, may be performed by NFT retirement software code 118, executed by hardware processor 114 of system 110.

Continuing to refer to FIGS. 1 and 3 in combination, flowchart 380 further includes communicating the collaborative activity to users 108a, 108b, and 108c (action 384). As noted above, the eligibility or users 108a, 108b, and 108c to participate in the collaborative activity may be determined based on respective user histories 162a, 162b, and 162c of users 108a, 108b, and 108c. The goal, quest, or other collaborative activity identified by system 110 in action 383 may be communicated to users 108a, 108b, and 108c in a number of different ways. For example, users 108a, 108b, and 108c may be notified of the identified collaborative activity through respective client devices 140a, 140b, and 140c, through any visual displays provided by computing platform 111, or by verbal cues issued by computing platform 111. In some implementations, users 108a, 108b, and 108c may collectively leverage their respective existing NFTs as a group in order to satisfy the goal, quest, or other activity by relinquishing respective existing NFTs 122a, 122b, and 122c to system 100, such as by transferring, donating, selling, or burning existing NFTs 122a, 122b, and 122c. Communication of the collaborative activity identified in action 383 to users 108a, 108b, and 108c, in action 384, may be performed by NFT retirement software code 118, executed by hardware processor 114 of system 110.

Referring to flowchart 380 in FIG. 3, with further reference to FIGS. 1 and 2, flowchart 380 further includes verifying that the collaborative activity requiring the relinquishment of the plurality of NFTs has been completed (action 385). It is noted that the plurality of NFTs required to be relinquished as part of the collaborative activity is the total number of NFTs relinquished by all participating users (e.g., users 108a, 108b, and 108c). Each of individual users 108a, 108b, and 108c may own one or more NFTs to relinquish, and in various implementations may relinquish one, a plurality, or none of the NFTs that user owns. The relinquished NFTs may be sequestered in an NFT wallet owned by location 120 or system 110. Participation tracking software application 252 resident on each of client devices 140a/240, 140b/240, and 140c/240 may be configured to update the progress of the collaborative activity by users 108a/208, 108b/208, and 108c/208 on secure transaction ledger 106/206 or system 110/210. Thus, action 385 may be performed by NFT retirement software code 118, executed by hardware processor 114 of system 110, either through receipt of data from one or more of client device 140a/240, 140b/240, or 140c/240, by reference to secure transaction ledger 106/206, or through receipt of data from one or more of client device 140a/240, 140b/240, or 140c/240 and by reference to secure transaction ledger 106/206.

It is noted that in use cases which the collaborative activity requiring the relinquishment of the plurality of NFTs goes uncompleted, various scenarios involving NFTs that have been relinquished as part of the collaborative activity are possible. In some use cases, relinquished NFTs may remain relinquished as a penalty for failure to complete the collaborative activity, while in other use cases, relinquished NFTs may be returned to the users having relinquished them during the collaborative activity.

Referring to FIGS. 1 and 3 in combination, flowchart 380 further includes to providing, in response to verifying in action 385, one or more new NFT(s) 121 for distribution to at least one of users 108a, 108b, and 108c (action 386). The one or more new NFT(s) 121 may be minted prior to verifying in action 385 or may be minted in response to verifying in action 385. After relinquishment of the plurality of NFTs required as part of the collaborative activity completed by users 108a, 108b, and 108c, system 110 may mint new NFT(s) 121 based on the relinquished inputs from users 108a, 108b, and 108c, as well as the outcome of the identified collaborative activity. New NFT(s) 121 may be rewarded to a single user or to a subset of users 108a, 108b, or 108c. However, the number of new NFT(s) 121 awarded by system 100 will typically be fewer than the number of existing NFTs 122a, 122b, 122c relinquished by users 108a, 108b, and 108c, resulting in a net reduction of NFTs, thereby advantageously enhancing NFT scarcity and value. In other words, in some implementations, at least one user that relinquishes an NFT will not receive a new NFT in exchange. Moreover, in some implementations, the value of new NFT(s) 121, whether they are fewer in number than the relinquished NFTs or not, exceeds the aggregate value of NFTs 122a, 122b, and 122c relinquished by users 108a, 108b, and 108c. However, in other implementations, new NFT(s) 121 may exceed the value of the lowest valued of relinquished NFTs 122a, 122b, and 122c, may exceed the value of the highest valued of relinquished NFTs 122a, 122b, and 122c, or may exceed the average value of relinquished NFTs 122a, 122b, and 122c

Referring once again to the exemplary use case described above involving a collaborative activity called the “Character A Footwear Challenge,” in this particular collaborative activity, Character A related NFTs including one or more specific footwear features, such as style, color, fasteners, and the like, are relinquished to system 110 to be burned. Users 108a, 108b, and 108c had the opportunity to leverage their existing NFTs 122a, 122b, and 122c to satisfy the required footwear features, as well as hunt throughout location 120 for other NFTs that include those features. If NFTs that collectively include all of the required footwear features were submitted to the interactive element 115 or other virtual depository within a predetermined period of time, at least one exceedingly rare new NFT 121 is minted and awarded to one or more of users 108a, 108b, or 108c.

In some implementations, hardware processor 114 of system 110 may execute NFT retirement software code 118 to receive relinquished existing NFTs 122a, 122b, 122c, to recycle one or more of existing NFTs 122a, 122b, and 122c to produce new NFT(s) 121 as one or more variant NFTs of one or more of existing NFTs 122a, 122b, 122c, or to mint an entirely new NFT(s) 121. Thus, the minting of new NFT(s) 121 in action 386 may be performed by NFT retirement software code 118, executed by hardware processor 114 of system 110.

It is noted that the expression “variant NFT” refers to an NFT corresponding to an NFT asset having one or more modified or enhanced features relative to the NFT asset identified by the existing NFT to which the variant NFT is compared. As a specific example, where an existing NFT corresponds to an image of Character A, new NFT(s) 121 in the form of variant NFT(s) may identify the same Character A depicted as having one or more of a different costume, different coloring, possessing different accessories, framed against a different background environment, wearing different expression, or stamped with a limited release number, date, time, or geolocation identifier, to name a few examples. Alternatively, or in addition, in some implementations, new NFT(s) 121 may include metadata enabling its recipient, e.g., user 108a, to enjoy a VR, AR, or MR experience at location 120 or another venue.

Moreover, in some implementations, new NFT(s) 121 may include metadata identifying their provenance. That is to say, new NFT(s) 121 may include metadata identifying one or more of the NFTs relinquished in exchange for new NFT(s) 121, the market value of those relinquished NFTs at the time they were relinquished, and the identities of the users who owned the relinquished NFTs at the time they were relinquished, to name a few examples.

In some implementations, the method outlined by flowchart 380 may conclude with action 386 described above. However, in other implementations, flowchart 380 may further include distributing new NFT(s) 121 to one or more of users 108a, 108b, and 108c (action 387). The determination of which of users 108a, 108b, or 108c will receive new NFT(s) 121 may be random, or may be performed utilizing a lottery system based on the rarity and number of NFTs contributed by each of users 108a, 108b, and 108c. The resulting new NFT(s) 121 may be rarer than all of the NFTs relinquished to system 100 by users 108a, 108b, and 108c. It is noted that, in some implementations new NFT(s) 121 distributed to one or more of users 108a, 108b, and 108c may grow scarcer as the number of users 108a, 108b, and 108c increases. Minting of new NFT(s) 121 in action 386 may be performed by NFT retirement software code 118, executed by hardware processor 114 of system 110.

It is noted that, in some implementations, new NFT(s) 121 may include a plurality of new NFTs, a respective one of which is distributed to each of users 108a, 108b, and 108c who owned one or more of the NFTs relinquished as part of the collaborative activity. However, in some implementations, one or more of users 108a, 108h, and 108c who to relinquished one or more of the plurality of NFTs required to be relinquished as part of the collaborative activity may not receive one of new NFT(s) 121 when new NFT(s) 121 is/are distributed. Alternatively, or in addition, one or more of new NFT(s) 121 may be distributed to one or more of users 108a, 108b, and 108c based on their respective user histories 162a, 162b, and 162c. For example, where user history 162a of user 108a reveals that user 108a has participated in a predetermined number of collaborative activities but has not yet been awarded a new NFT for his/her participation, one of new NFT(s) 121 may be distributed to that user in action 387 whether or not user 108a relinquished existing NFT 122a as part of the collaborative activity. Action 387 may be performed by NFT retirement software code 118, executed by hardware processor 114 of system 110, and, in some implementations, utilizing one or more of user histories 162a, 162b, and 162c.

Once existing NFTs 122a, 122b, and 122c have been relinquished, hardware processor 114 of system 110 may execute NFT retirement software code 118 to report the details of that relinquishment on secure transaction ledger 106, which may serve as the sole repository of that activity. Moreover, once new NFT(s) 121 is/are minted and/or distributed, hardware processor 114 of system 110 may further execute NFT retirement software code 118 to report the details of the new minting and distribution on secure transaction ledger 106. Moreover, in some implementations relinquishment of existing NFTs 122a, 122b, and 122c may cause hardware processor 114 of system 110 to execute NFT retirement software code 118 to revoke or burn existing NFTs 122a, 122b, and 122c.

It is noted that the actions described by flowchart 380 may advantageously be performed by system 110 as an automated process. As defined in the present application, the term “automated,” refers to systems and processes that do not require the participation of a human user, such as a human system administrator. For example, although in some implementations a human system administrator may review the performance of the systems and methods disclosed herein, and, in some cases may adjust their performance over time, that human involvement is optional. Thus, in some implementations, the process described by flowchart 380 may be performed under the control of hardware processing components of system 110.

Thus, the present application discloses systems and methods for performing NFT retirement that address and overcome the deficiencies in the conventional art. From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a hardware processor and a system memory storing a software code;
the hardware processor configured to execute the software code to:
determine a number of users present at a location at a starting time of a non-fungible token (NFT) acquisition event;
identify, based on the number of users present at the location at the starting time, a collaborative activity for the users, the collaborative activity requiring a relinquishment of a plurality of NFTs;
communicate the collaborative activity to the users;
verify that the collaborative activity requiring the relinquishment of the plurality of NFTs has been completed; and
provide, in response to verifying, at least one new NFT for distribution to at least one of the users;
wherein (i) a value of the at least one new NFT exceeds a value associated with the plurality of NFTs relinquished, or (ii) a number of the plurality of NFTs relinquished exceeds a number of the at least one new NFT.

2. The system of claim 1, wherein the at least one new NFT consists of a single new NFT, and wherein the hardware processor is further configured to execute the software code to:
distribute the single new NFT to only one of the users.

3. The system of claim 2, wherein the only one of the users is randomly selected.

4. The system of claim 1, wherein the at least one new NFT comprises a plurality of new NFTs fewer in number than a number of the plurality of NFTs relinquished, and wherein the hardware processor is further configured to execute the software code to:
distribute one of the plurality of new NFTs to each of the users that relinquished one or more of the plurality of NFTs relinquished.

5. The system of claim 1, wherein the location comprises a real-world location.

6. The system of claim 1, wherein the location includes an interactive element, and wherein
communicating the collaborative activity comprises using the interactive element to communicate with the users verbally or via a visual display.

7. The system of claim 1, wherein the location comprises a virtual interactive environment that provides at least one of a virtual reality (VR), augmented reality (AR), or mixed reality (MR) experience to the users.

8. The system of claim 1, wherein before determining the number of users present at the location at the starting time, the hardware processor is further configured to executed the software code to:
broadcast an announcement of the NFT acquisition event, the announcement identifying the starting time and the location for the NFT acquisition event.

9. The system of claim 1, wherein the collaborative activity requires each of the users to relinquish at least one of the plurality of NFTs.

10. The system of claim 1, wherein the hardware processor is further configured to execute the software code to:
distribute the at least one new NFT, wherein at least one of the users who relinquished an NFT does not receive the at least one new NFT.

11. A method for use by a system including a hardware processor and a system memory storing a software code, the method comprising:
determining, by the software code executed by the hardware processor, a number of users present at a location at a starting time of a non-fungible token (NFT) acquisition event;
identifying, by the software code executed by the hardware processor based on the number of users present at the location at the starting time, a collaborative activity for the users, the collaborative activity requiring a relinquishment of a plurality of NFTs;
communicating, by the software code executed by the hardware processor, the collaborative activity to the users;
verifying, by the software code executed by the hardware processor, that the collaborative activity requiring the relinquishment of the plurality of NFTs has been completed; and
providing, by the software code executed by the hardware processor in response to verifying, at least one new NFT for distribution to at least one of the users;
wherein (i) a value associated with the at least one new NFT exceeds a value of the plurality of NFTs relinquished, or (ii) a number of the plurality of NFTs relinquished exceeds a number of the at least one new NFT.

12. The method of claim 11, wherein the at least one new NFT consists of a single new NFT, the method further comprising:
distributing, by the software code executed by the hardware processor, the single new NFT to only one of the users.

13. The method of claim 12, wherein the only one of the users is randomly selected.

14. The method of claim 11, wherein the at least one new NFT comprises a plurality of new NFTs fewer in number than a number of the plurality of NFTs relinquished, the method further comprising:
distributing, by the software code executed by the hardware processor, one of the plurality of new NFTs to each of the users that relinquished one or more of the plurality of NFTs relinquished.

15. The method of claim 11, wherein the location comprises a real-world location.

16. The method of claim 11, wherein the location includes an interactive element, and wherein communicating the collaborative activity comprises using the interactive element to communicate with the users verbally or via a visual display.

17. The method of claim 11, wherein the location comprises a virtual interactive environment that provides at least one of a virtual reality (VR), augmented reality (AR), or mixed reality (MR) experience to the users.

18. The method of claim 11, the method further comprising:
broadcasting, by the software code executed by the hardware processor before determining the number of users present at the location at the starting time, an announcement of the NFT acquisition event, the announcement identifying the starting time and the location for the NFT acquisition event.

19. The method of claim 11, wherein the collaborative activity requires each of the users to relinquish at least one of the plurality of NFTs.

20. The method of claim 11, further comprising:
distributing, by the software code executed by the hardware processor, the at least one new NFT, wherein at least one of the users who relinquished an NFT does not receive the at least one new NFT.
